(19) United States
(12) Patent Application Publication
(10) Pub. No.: US 2008/0086353 A1
(43) Pub. Date: Apr. 10, 2008

(54) Server level summary information of resource utilization

(75) Inventors: Rahul Motwani, Redmond, WA (US); Nichol Viton, Seattle, WA (US); Roy Kayahara, Richmond Hill (CA)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/542,879

(22) Filed: Oct. 4, 2006

(51) Int. Cl. G06F 15/02

(52) U.S. Cl. 705/9

(57) ABSTRACT

Embodiments provide a project management application that is configured to provide a server level summary of resource utilization. In an embodiment, a project management application provides a server level summary resource assignment (SRA). The server level SRA can be presented in a user interface as a summary rollup of the utilization of a resource for an associated server. In an embodiment, a server level SRA is updated and/or generated on an application server during a publish operation. After the publish operation, the server level SRA can be accessed and used to provide a summary of an availability and/or allocation of a resource that is associated with one or more projects and/or one or more resource plans.

### RELATED APPLICATIONS

This application is related to U.S. patent application Ser. No. 10/308,712, filed Dec. 2, 2002, and entitled, “Method and System for Generating Summary Information of Resource Allocation” and U.S. patent application Ser. No. 11/417,803, filed May 4, 2006, and entitled, “Project Resource Plans,” which are hereby incorporated by reference in their entireties.

### BACKGROUND

Project management applications allow users to create project management schedules for organizing and managing tasks, resources and labor associated with a variety of projects. A project management application can be used to track and allocate resources, such as individuals, machines, computing devices, etc., since it is common practice for a resource to be associated with multiple projects and assignments. For example, a project manager can use a project management application to review a current allocation of resources to determine which resources have the time and experience necessary to accomplish a particular objective.

One method of determining the availability of a particular resource is to view all assignments associated with the resource throughout an enterprise. The assignment information associated with the resource is typically pulled down from a central repository to a client workstation and generated on the client. This can be a cumbersome and inefficient process due to the amount of delay and computational load associated with downloading and compiling resource data to determine the availability of the particular resource.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide a project management application that is configured to provide and manage information associated with resource availability and allocation. In an embodiment, the project management application is configured to provide a server level summary resource assignment (SRA). The server level SRA can comprise a summary rollup of the utilization of a resource for an associated server. In various embodiments, a server level SRA is used to track a work resource, such as a person, computing device, machine, etc. In an embodiment, a server level SRA is updated and/or generated on an application server as part of a publish operation. After the publish operation, the server level SRA can be accessed and used to provide a summary of an availability and/or allocation of a resource that is associated with one or more projects and/or one or more resource plans.

A server level SRA can be generated for a resource plan or a project or a combination thereof. The server level SRA can be used during scheduling to ensure that the impact of other projects and/or resource plans on the availability of shared resources is considered during resource leveling and resource substitution. The server level SRA can be accessed and/or presented to determine how to use and/or allocate a particular resource based on a current availability and/or unavailability of the particular resource.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a diagram of a system for managing resources associated with one or more projects and/or one or more resource plans.

FIGS. 2A-2B depict a flowchart illustrating the generation and management of one or more server level SRAs.

FIGS. 3A-3C illustrate aspects of a user interface of a project management application.

FIG. 4 illustrates aspects of a user interface of a project management application.

FIG. 5 illustrates aspects of a user interface of a project management application.

FIG. 6 is a block diagram illustrating a computing environment for implementation of various embodiments described herein.

### DETAILED DESCRIPTION

Embodiments provide a project management application that is configured to provide and manage information associated with resource availability and allocation. In an embodiment, the project management application can generate and manage a server level summary resource assignment (SRA). The server level SRA can comprise a summary rollup of the utilization of a resource, such as an enterprise resource for example, for an associated server. In various embodiments, a server level SRA can be used to track a work resource, such as a person, computing device, machine, etc. In an embodiment, a server level SRA is updated and/or generated using an application server as part of a publish operation. After the publish operation, the server level SRA can be accessed and/or distributed to provide a summary of an availability and/or allocation of a resource that is associated with one or more projects and/or one or more resource plans.

In an embodiment, server level SRA records can be updated on an application server when server-side changes are made, thereby negating the need to open all the appropriate projects and resource plans that use the resource to obtain availability data for that resource. For example, the server level SRA can be generated by an application server that is executing the project management application to manage resource information associated with a project and/or resource plan in an enterprise setting. A resource plan can be used to reserve a resource for an amount of time without actually assigning a task to the resource. A project can be used to reserve a resource for an amount of time by assigning one or more tasks to a particular resource.

A server level SRA can be generated for a resource plan or a project or a combination thereof. The server level SRA can be used during scheduling to quickly ensure that the impact of other projects and/or resource plans on the availability of shared resources is considered during resource leveling and resource substitution. For example, as a resource is added to a project team or resource plan, a server level SRA can be used to view information for all other projects and/or resource plans that the resource is associated with. Accordingly, a project manager or other interested party can use the server level SRAs to obtain an accurate picture of resource utilization across projects and/or resource plans since all the demands against the resources are known and available. The server level SRA can be accessed and/or presented to determine how to use and/or allocate a particular resource based on a current availability and/or unavailability of the particular resource.

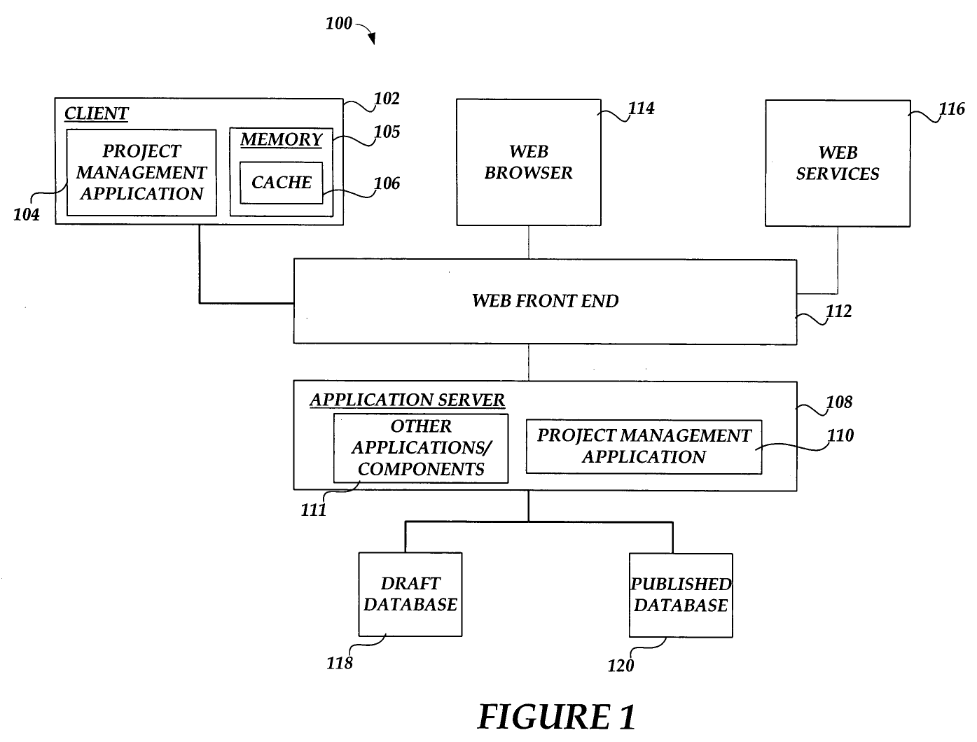

FIG. 1 is a diagram of a system 100 for managing resources associated with one or more projects and/or one or more resource plans, under an embodiment. As shown in FIG. 1, the system 100 includes a client computing device 102. The client computing device 102 includes a project management application 104, system memory 105, and a cache 106, but is not so limited. While one client computing device 102 is shown in FIG. 1, the system 100 can include multiple client computing devices 102. The system also includes an application server 108 which includes a project management application 110 and other applications/components 111, but is not so limited. In one embodiment, the other applications/components 111 include one or more application programming interfaces (APIs) that are configured to manage aspects of server level and/or project level SRAs. The project management application 110 can include additional functionality as compared with the project management application 104 of the client computing device 102.

The system 100 includes a web front end 112 in communication with the application server 108. The web front end 112 provides an interface for the client computing device 102, a web browser component 114, and a web services component 116 to interact with the application server 108. The system 100 also includes a draft database 118 and a published database 120 that serve as repositories for information associated with one or more resources, one or more projects, and/or one or more resource plans, but are not so limited. In various embodiments, server level and project level SRAs can be stored and managed using the published database 120. In an alternative embodiment, the draft database 118 and a published database 120 are incorporated on a single serving computer rather than being implemented as disparate components. In one embodiment, the draft database 118 and published database 120 comprise structured query language (SQL) databases. While various aspects are shown with respect to the system 100 of FIG. 1, other implementations are available.

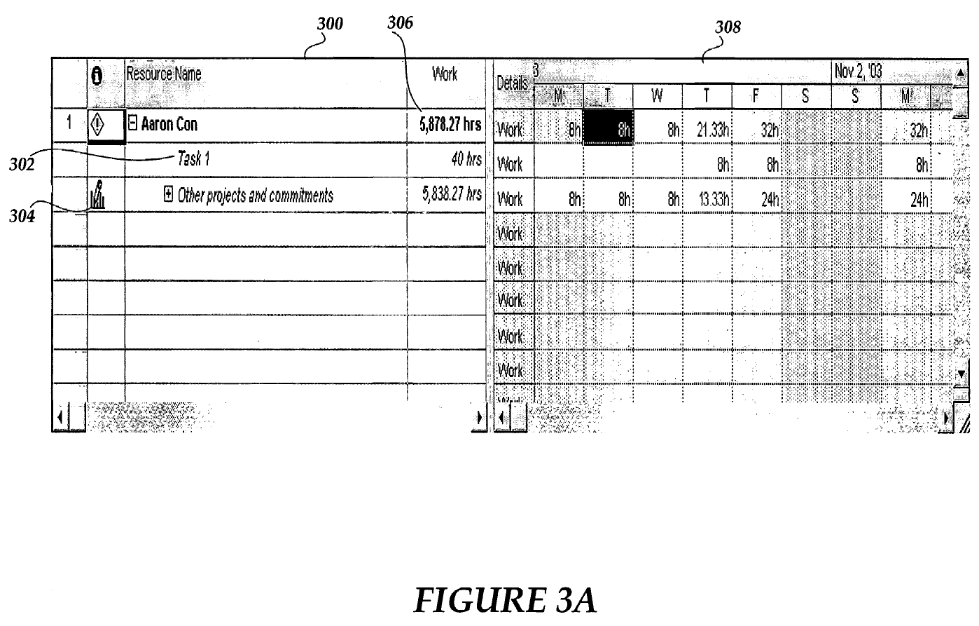

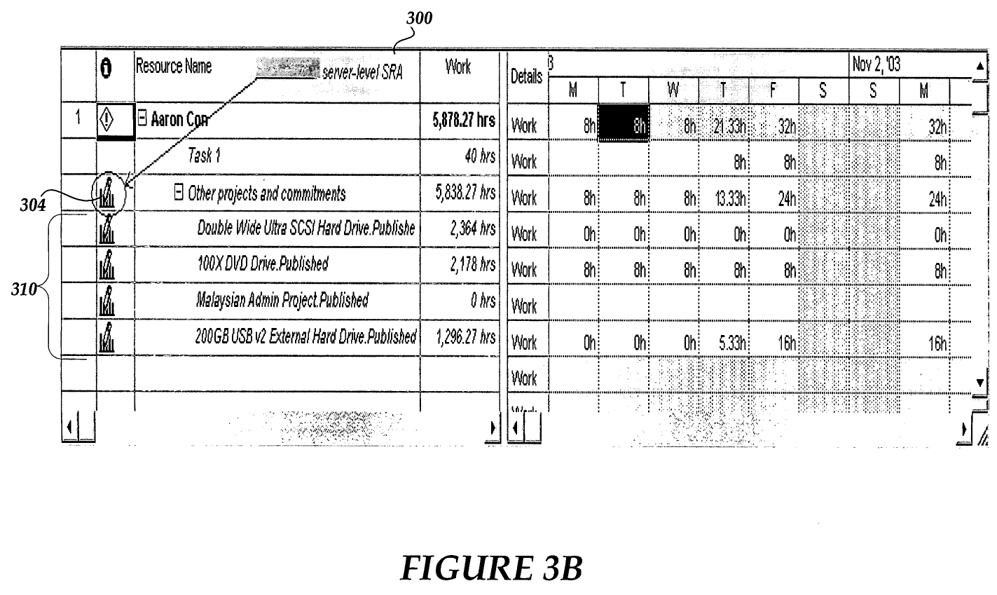

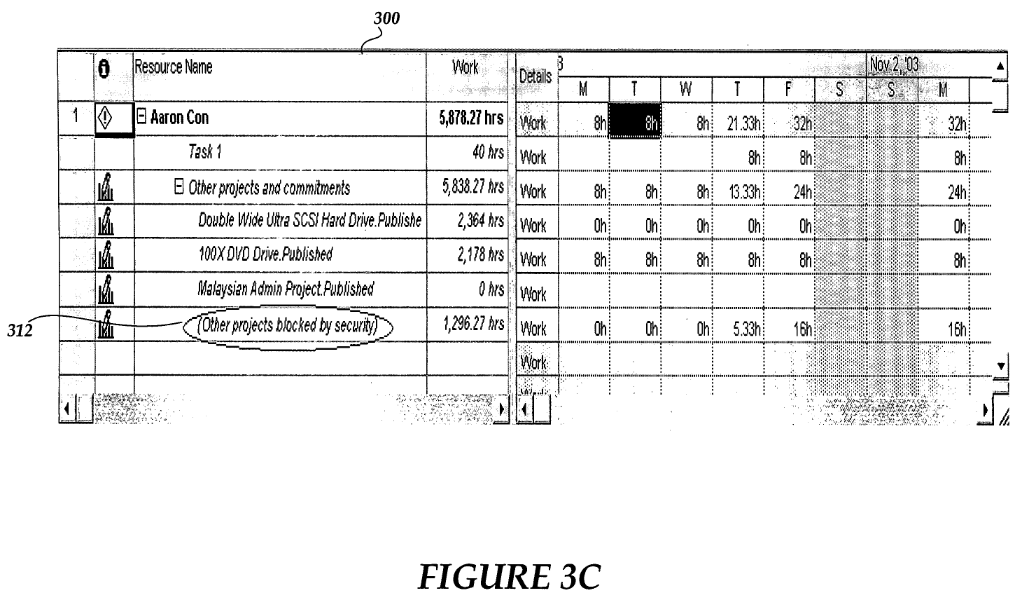

The application server 108 includes a project management application 110 and a number of APIs that are configured to provide resource utilization data to users of the system 100. In an embodiment, the components of the application server 108 operate to reduce data clutter by providing resource utilization data from other projects and/or plans without overwhelming a user with unwanted and/or unnecessary assignment and other data as part of a “Resource Usage” view (see FIGS. 3-5). The application server 108 can provide a server level SRA so that users of a project management application are provided with a summary overview of resource allocation and/or availability. For example, a project manager can use a server level SRA to obtain a current picture of how certain resources are being used (e.g. what a resource is working on), including the availability of the resources.

A server level SRA can comprise a server-wide roll-up of resource related data and can be used by a user to quickly and efficiently determine resource availability and/or allocation. The server level SRA provides an accumulated summary of the various demands on a resource's time. In one embodiment, the server level SRA comprises a roll-up of all SRAs (e.g. project level SRAs), resource plans, and/or other data and is presented as a top level node of a user interface (see FIG. 3A). That it, the subordinate information is included or rolled-up into the top level node comprising the server level SRA. A server level SRA can be generated by the application server in association with the publication of a project. The server level SRA can be updated and accessed from the published database 120. For example, the server level SRA can be updated when an enterprise resource is added to a project team.

In an embodiment, a server level SRA is associated with a project when a resource is added to a project team. Additionally, a server level SRA can be generated for each resource. Accordingly, a user, such as a project manager for example, can use a server level SRA to view a current utilization of one or more resources in determining a resource's current and/or future availability and/or allocation. The ability to use the server level SRA is beneficial for situations in which one or more resources are being used and/or are associated with multiple projects and it is not desirable to access all associated data at once. Correspondingly, the server level SRA operates to reduce the volume of SRA data that is moved across a network when providing resource information to users of the system 100.

As described above, a server level SRA can comprise a summary rollup of the utilization of an enterprise resource for an associated server, such as the entire application server 108 for example. The server level SRA can be generated during a publishing or publish operation. Publishing a project refers to an operation wherein project and other data is transferred from the draft database 118 to the published database 120, which includes the generation of the server level SRA(s). That is, a server level SRA can be generated and made available using the application server 108 as part of the publishing process for projects and/or resource plans, but is not so limited. In an embodiment, the project management application 104, 110 includes an interface configured to enable a user to execute the publish operation and thereby generate one or more server level SRA(s) associated with one or more resources.

A resource plan provides a user with the ability to pre-allocate or assign some portion of a resource's time for a particular project or group of projects, without actually having to designate a particular assignment or task. When a resource plan is created, a server level SRA can be generated to represent the impact of that plan on resource availability. Accordingly, once a project is published, one or more server level SRAs can be generated as a result of specifying requirements for one or more resources in the resource plan. The server level SRA can be viewed by a user, using a Resource Usage view (see FIGS. 3-5) for example, of the project management application 104.

In one embodiment, a project can be automatically updated with the latest SRAs (e.g. server, project, resource plan, etc.) when a project is created or opened, thereby ensuring that the latest resource utilization information is available to users of the system 100. As described above, the application server 108 is configured to calculate and manage server level SRAs. The system 100 is configured to account for situations in which multiple projects using the same resource(s) are being published simultaneously by using the components of the application server 108 to calculate and manage server level SRAs.

In an embodiment, the components of the application server 108 manage a server level SRA by placing a project publish call on a queue of the application server 108. The queue of the application server 108 operates to execute project publish calls in order (e.g. current to oldest), accounting for situations in which multiple projects using the same resource(s) are being published simultaneously. As described herein, the server level SRA provides a summary view of a resource's current assignment allocation organized by one or more projects and/or one or more resource plans and can comprise a record stored in the published database 120. A table can be used to generate the record, as described below. The project management application 110 can record data on a greater number of resources using the server level SRA, while avoiding a need to parse the data from the entire database.

In one embodiment, a server level SRA can be accessed from the published database 120 by a client computing device 102, web browser 114, or other computing system. The server level SRA can be accessed without having to load separate project level SRAs for each project. Accordingly, data transferal and load times can be decreased due in part to the fact that the separate project level SRAs do not have to be loaded when accessing the server level SRAs. Thereafter, if a user so chooses, the project level SRAs can be accessed by expanding the server level SRA. Accordingly, an affirmative action is required by a user who wishes to access project level SRAs. The access of the project level SRAs also can be described as demand loading of detailed SRAs. Additionally, baseline and earned value fields are removed from the SRAs since these fields are meaningless as resource-level fields and can be confusing to users.

In various embodiments, a user can access the application server 108 using the web browser 114 and use the project management application 110 to create a detailed plan for completing a project. A user can also use the project management application 104 to create a detailed plan for completing a project. The user can also use the web front end 112 and application server 108 to create a resource plan that reserves or assigns one or more resources for a specific time or time period. Once generated, the user can use the server level SRA to ascertain resource availability and/or allocation without having to load or view each project level SRA associated with the resource as described above. The user can expand the server level SRA to obtain further detail regarding other projects and commitments (see FIGS. 3A-3C). The information associated with other projects and commitments can be viewed if the user chooses to expand the server level SRA.

Take for example that a representative project can include a number of assignments or tasks and associated resources assigned to the assignments. Assignments can be described as an association between a specific task and a resource. Thus, a project can include multiple tasks and each task can be assigned to one or more resources. Once a user assigns a resource, an assignment is created for that resource by the project management application 104. In a corresponding manner, a resource plan can be used to block out or assign a time or period of time for one or more resources. A project manager or other user can use the information associated with a project and/or resource plan to determine which resources are available to complete each assignment in a project. However, an enterprise can include multiple projects and/or resource plans in which resources are allocated or reserved.

As described above, the server level SRA allows a project manager to quickly and efficiently determine assignments, tasks, and/or plans that a particular resource may be associated with. Thus, the project manager is able to view the server level SRA and/or project level SRA to determine if a particular resource has sufficient unallocated time to assist with a current or future project. The server level SRA provides the project manager with important utilization information by generating a summary of assignments, tasks, and/or plans allocated to a particular resource. Moreover, the server level SRA allows a project management application to record data on a greater number of resources, while avoiding a need to parse unnecessary data from the entire published database 120 when called.

As described herein, a server level SRA can be generated once a project and/or a resource plan is published rather than being tied to a save operation. In an embodiment, a user can use the project management application 104 to save project data to the draft database 118. That is, a save operation operates to move all of the associated project data into the draft database 118. However, this data is not available for all users to view, other than the user (e.g. a project manager (PM)) that is creating the project. The user can continue to work on the draft copy of a project until the user is ready to share the information in the project with others. When the user is ready to share the information, the user can publish the project which operates to transfer (e.g. pushed, pulled, copied, etc.) the data from the draft database 118 to the published database 120, thereby making the information available to other users who have access to view this data and for resources to see and enter status using and timesheet information on their tasks in the project. Accordingly, publishing a project or resource plan operates to make the information associated with the project or resource plan available to other users of the system 100.

Correspondingly, once a project or resource plan is published, the information associated with the server level SRA is made available to certain users having access to the resource data. In one embodiment, saving a project or resource plan operates to store the information associated with the project or resource plan in the draft database 118, but does not operate to generate a server level SRA. Once a user is ready to publish a project or resource plan however, the information stored in the draft database 118, including recent changes, can be transferred into the published database 120 and made available to users of the system 100.

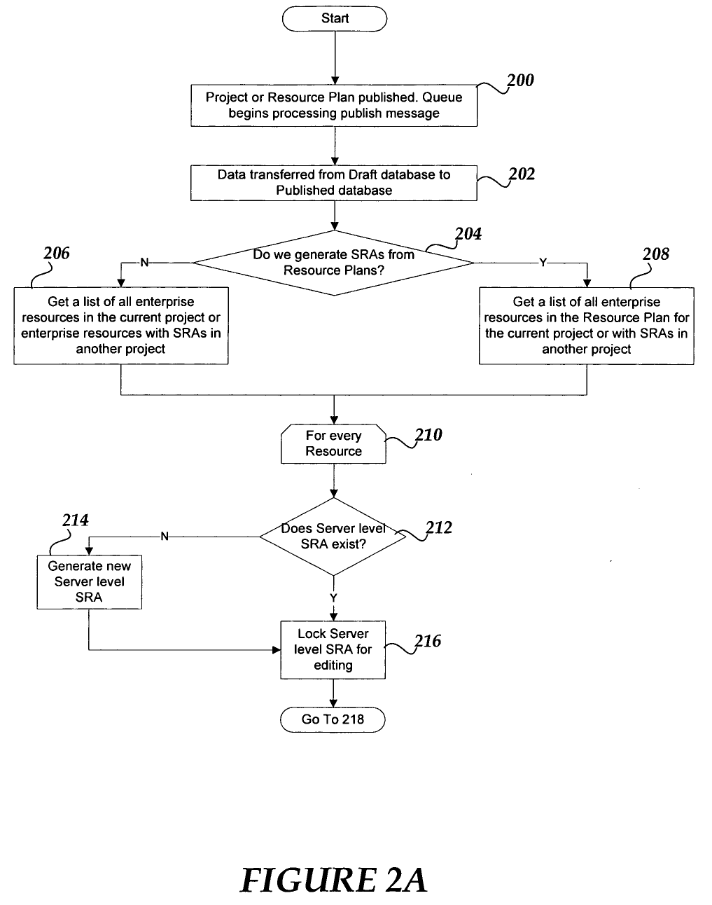

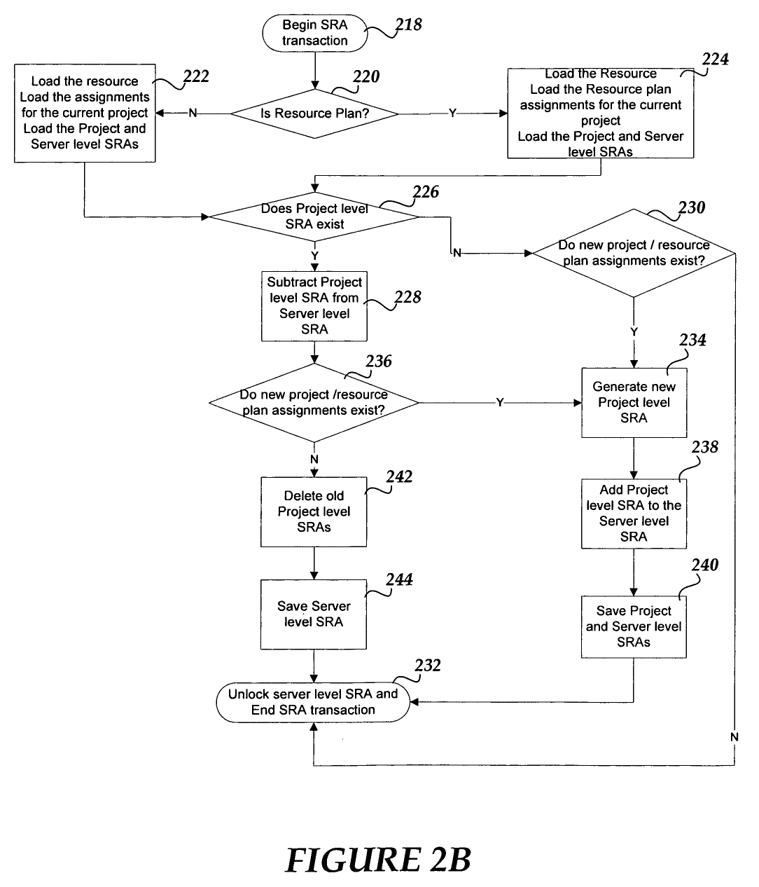

FIGS. 2A-2B depict a flowchart illustrating the generation and management of one or more server level SRAs under an embodiment. As described above, a server level SRA can be associated with each resource and provides a summary of the utilization for each resource that may be associated with multiple projects and/or resource plans. At 200, a project or resource plan is published by a user. A user interface can include a menu item, button, or other interactive tool that allows the user to designate a publish operation. After publishing the project or resource plan, a queue begins processing a publish message to alert other users that the information associated with the project or resource plan is not currently available. Generally, the generation of the server level SRA begins by retrieving a resource in a current project or resource plan.

At 202, the application server 108 transfers the data associated a project and/or resource plan from the draft database 118 to the published database 120. That is, the assignments, tasks, and/or plans currently allocated to a resource are retrieved from the draft database 118 and stored in the published database 120. The retrieved data can then be parsed and located in the SRA data fields (see the Table below). The data parsed from the assignments can include information related to the amount of remaining work, the amount of time already accrued, the amount of time of actual work, and/or the expected total time required, but is not so limited. Once all the data is parsed, the data fields of the server level SRA can be summed by the application server 108 to show the total amount of time associated with the project and/or resource plan (see FIGS. 3A-3C). Thus, a project manager or other user can view the server level SRA(s) to determine a current allocation of time for a particular resource in a convenient and efficient manner.

At 204, the application server 108 determines if a server level SRA is to be generated from the resource plan associated with the project or from the assignments in the project. If a server level SRA is not going to be generated from the resource plan, the flow continues to 206, and the application server 108 obtains a list of all enterprise resources in the current project or enterprise resources with already existing project level SRAs for the current project. If a SRA is going to be generated from the projects associated with the resource plan, the flow continues to 208, and the application server 108 gets a list of all enterprise resources in a resource plan for the current project or enterprise resources with already existing project level SRAs for the current project. At 210, each resource associated with the project(s) and/or resource plan(s) is considered and a server level SRA can be generated and/or updated for each resource.

At 212, the application server 108 determines whether a server level SRA currently exists in the published database 120. If a server level SRA does not currently exist, the flow continues to 214 and the application server 108 generates a new server level SRA. If a server level SRA does exist in the published database 120, the flow continues to 216 and the application server 108 locks the server level SRA for editing. The flow then continues to 218 and a SRA transaction begins.

At 220, it is determined whether the SRA transaction is for a resource plan. If the SRA transaction is not for a resource plan, the flow proceeds to 222, and the application server 108 loads the resource, any assignments for the current project, and/or the project level and server level SRAs. Otherwise, if the SRA transaction is for a resource plan, the flow proceeds to 224 and the application server 108 loads the resource, any resource plan allocations for the current project, and/or the project level and server level SRAs. At 226, the application server 108 determines whether a project level SRA exists. If a project level SRA does exist, the flow proceeds to 228, and the application server 108 subtracts the project level SRA data from the server level SRA data.

If a project level SRA does not exist, the flow proceeds to 230, and the application server 108 checks to see whether new assignments exist for the a project and/or resource plan. If no new assignments exist, the flow continues to 232 and the application server 108 unlocks the server level SRA and the SRA transaction ends. Otherwise, the flow continues to 234 and the application server 108 generates one or more new project level SRAs. At 238, the application server 108 adds the data associated with one or more new project level SRAs to the server level SRA data. At 240, the application server 108 saves the project and server level SRAs in the published database 120, and the flow continues to 232 where the application server 108 unlocks the server level SRA and the SRA transaction ends.

At 236, the application server 108 checks to see whether new assignments exist for a project and/or resource plan. If new assignments exist, the flow proceeds to 234 and continues as described above. If no new assignments exist, the flow proceeds to 242 and the application server 108 deletes old project level SRAs. At 244, the application server saves the server level SRA in the published database 120. After saving the server level SRA, the flow continues to 232, and the application server 108 unlocks the server level SRA and the SRA transaction ends.

FIGS. 3A-3C illustrate aspects of a user interface 300 of a project management application, under an embodiment. The user interface 300 is displaying a resource usage view which includes information associated with one or more resources. As shown in FIG. 3A, there is a single identified resource that is associated with the current project. The resource is identified as “Aaron Con.” The resource has one assignment 302, identified as “Task 1,” in the current project. The resource usage view also includes a server level SRA 304.

The server level SRA 304 includes utilization data associated with the identified resource and also informs the user that the identified resource has “Other projects and commitments.” The “Other projects and Commitments” can include other projects and commitments, such as one or more resource plans for example, that the resource is associated with. As shown, the identified resource has an allocation of 5,878.27 total hours 306, 40 hours of which are associated with the current project. The server level SRA 304 informs the user that the identified resource has an allocation of 5,838.27 hours to other projects and commitments. Thus, the resource usage view including the server level SRA 304 provides a quick summary of the hours associated with the identified resource including the hours associated with a current project and the hours associated with other projects and commitments. As shown in FIG. 3A, the user interface 300 also includes an adjustable calendar view 308 showing hours on a daily, weekly, or other calendar-oriented basis.

As described above, the server level SRA 304 provides a summary roll-up of utilization information associated with a resource. A user can use the server level SRA to determine the availability and/or allocation for the resource. If the user wishes to learn more about the other projects and commitments, the user can use the user interface 300 to expand the server level SRA 304. For example, the user can click on the “+” to expand the server level SRA 304. If the user chooses to expand the server level SRA 304, other data, including other project data and resource plan data, is accessed from the published database 120. For example, the additional information can be pushed to the user or pulled from the published database 120.

FIG. 3B shows the user interface 300 after the user has expanded the server level SRA 304 that is associated with the resource. As shown, additional information (project name, resource plan name, time phase information, etc.) associated with a number of other projects 310 is provided to the user after expanding the server level SRA 304. Since the user has to take affirmative action to obtain the additional information, the amount of data initially presented does not overwhelm the user. Moreover, it takes less time to present the server level SRA since the additional information has not been accessed from the published database 120 or cache 106.

When a user chooses to expand the server level SRA to obtain additional information, an automatic synchronization occurs with the application server 108, including the loading of any subordinate SRAs (e.g. project level SRAs). In an embodiment, each of the other projects 310 comprises a project level SRA associated with the resource. The information associated with each project includes a project identifier or name and a number of hours associated with each project. The sum of these other projects and commitments is associated with the server level SRA.

FIG. 3C depicts the user interface 300 once the user has expanded the server level SRA 304 associated with the resource. In this instance, the user does not have access to the information associated with one of the other projects 312. Thus, the application server 108 will not provide details other than the number of hours associated with this project. Moreover, the user will not be able to obtain further information for this project 312 until the user is given proper access or permission, such as valid user credentials for example.

As described above, server level and project level SRAs are created as a consequence of publishing a project that can be associated with scheduling a resource. Accordingly, the permission to create, modify, and/or delete a project level SRA (which operates to update the server level SRA) is governed by the ability to publish an updated project plan. In one embodiment, if the permission is granted for a project, it includes permission(s) on the SRAs.

In various embodiments, a resource can be secured independently of a project or projects and associated with a server level SRA. That is, a resource can only be assigned to a project team by a user who has permission to assign on the resource. Accordingly, resources cannot be assigned by someone who is not authorized to do so. Once the resource has been assigned to a project, the scheduling of the project can be used to control the content of the server level and project level SRAs.

In an embodiment, a user can use the application server 108 to set up permissions which allow various levels of access to resource information. For example, permission to view a server level SRA can be granted to anyone who has “View Enterprise Resource Data” permission on the resource and to projects to which the resource is assigned (e.g. to users who can view the project using the resource.) In an embodiment, permission to view a project level SRA requires that the user have permission to view the server level SRA and to view the project associated with the SRA. For example, if the user does not have permission on the project, the project name and other identifying information is not loaded into the user interface 300 (e.g. Resource Usage view), and the user interface 300 will only display the resource utilization data (e.g. time information).

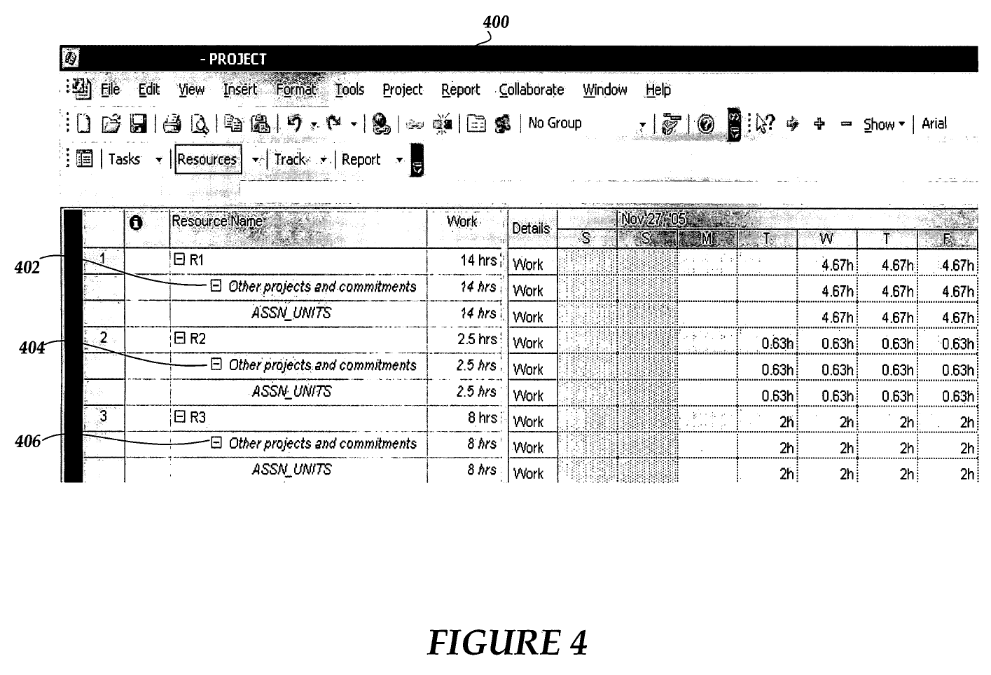

FIG. 4 illustrates aspects of a user interface 400 of a project management application, under an embodiment. The user interface 400 is displaying a resource usage view which includes information associated with one or more resources. The user interface 400 is providing information associated with a number of resource plans. As shown in FIG. 4, there are 3 resources, R1 through R3, that have time reserved in the resource plan called ‘ASSN_UNITS’. As described above, a resource plan can be used to reserve or allocate a resource's time without actually assigning a specific task to the resource.

Each resource (R1-R3) includes an associated server level SRA 402-406. For this example, there are no current resource plans or projects associated with the resources (R1-R3). As described above, the user has expanded the server level SRAs 402-406 to obtain additional information regarding the allocation of a particular resource. The server level SRAs 402-406 operate to inform the user that the identified resource has “Other projects and commitments” which has been expanded to show “ASSN_UNITS.” The expanded server level SRA provides information to the user regarding an amount of time that has been reserved for each resource. Thus, the server level SRAs 402-406 provide a quick summary of the total hours allocated or reserved for each resource.

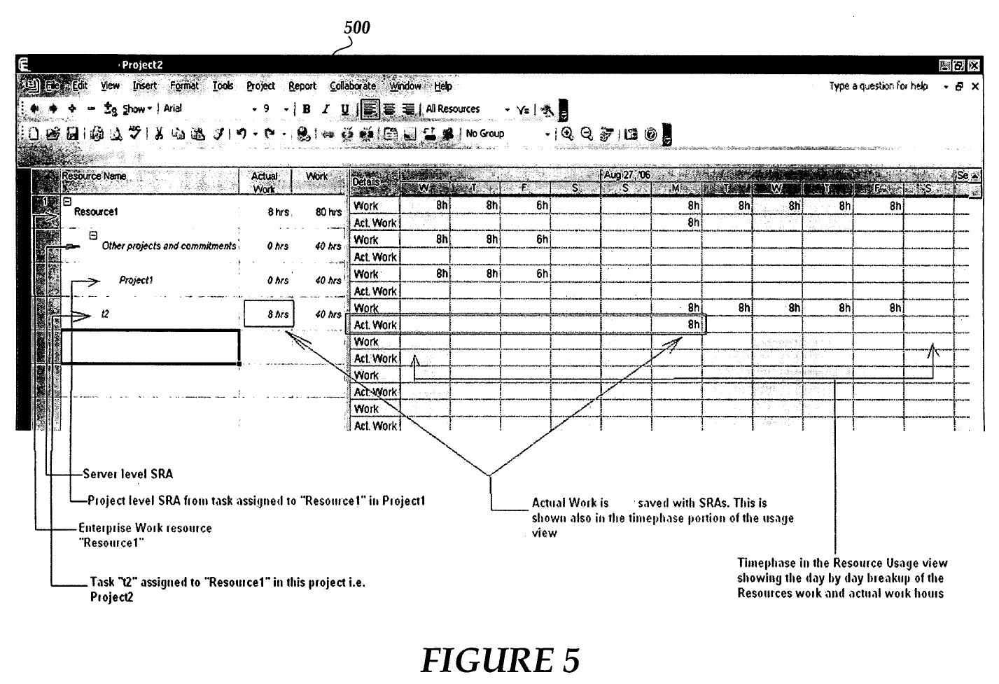

FIG. 5 illustrates aspects of a user interface 500 of a project management application, under an embodiment. The user interface 500 is displaying a resource usage view which includes information associated with a resource. As shown in FIG. 5, the user is also able see the “actual work” for the resource. The actual work data is also maintained by the project management application. Actual work refers to the actual work that the resource has performed on a particular task. The actual work will not always equal the total work. That is, the actual work can be less than the total work.

For example, a user may have scheduled a particular resource for a week on a project, but the work was actually completed in 4 days, which is represented as actual work. The server level SRA and the project level SRA can include the actual work for each resource. The actual work indication operates to provide an efficiency measure for a particular resource. A user can right click on the timeframe portion of the user interface 500 and select to show the actual work time.

In an embodiment, the application server 108 uses the Table below and a number of APIs to generate and manage a server level SRA.

TABLE

| Field | Type | Description |
|---|---|---|
| ASSN_UID | UID | Unique identifier of this |
| | | assignment row. |
| PROJ_UID | UID | Unique identifier of the |
| | | project |
| ASSN_NAME | NAME(nvarchar) | Stores the name of the |
| | | summary resource assignment. |
| RESERVED_DATA | char(1) | Reserve for internal use |
| | | (RFU) |
| ASSN_ACT_FINISH | Datetime | |
| ASSN_ACT_START | Datetime | |
| ASSN_RES_TYPE | Bit | |
| ASSN_IS_OVERALLOCATED | Bit | Same as ASSN table |
| ASSN_WORK_CONTOUR | Smallint | Same as ASSN table |
| ASSN_START_VAR | Int | Same as ASSN table |
| ASSN_FINISH_VAR | Int | Same as ASSN table |
| RES_UID | UID | Unique identifier of the |
| | | enterprise resource |
| | | associated with this |
| | | summary resource |
| | | assignment row. |
| ASSN_START_DATE | Datetime | Start Date for the summary |
| | | resource assignment |
| ASSN_FINISH_DATE | Datetime | Finish Date for the |
| | | summary resource |
| | | assignment |
| ASSN_DELAY | Int | Same as ASSN table |
| ASSN_DELAY_FMT | Smallint | Same as ASSN table |
| ASSN_LEVELING_DELAY | Int | Same as ASSN table |
| ASSN_COST_RATE_TABLE | Smallint | RFU |
| ASSN_MATERIAL_RATE_FMT | Smallint | RFU |
| ASSN_UNITS | decimal(25,6) | Same as Resource Units in |
| | | MSP_ASSIGNMENTS |
| | | table |
| ASSN_WORK | decimal(25,6) | Assignment Work on the |
| | | resource |
| ASSN_ACT_WORK | decimal(25,6) | Assignment Actual Work |
| ASSN_REG_WORK | decimal(25,6) | |
| ASSN_REM_WORK | decimal(25,6) | Assignment Remaining |
| | | Work on the resource |
| ASSN_COST | decimal(25,6) | RFU |
| ASSN_ACT_COST | decimal(25,6) | RFU |
| ASSN_REM_COST | decimal(25,6) | |
| ASSN_OVT_WORK | decimal(25,6) | |
| ASSN_ACT_OVT_WORK | decimal(25,6) | |
| ASSN_REM_OVT_WORK | decimal(25,6) | |
| ASSN_ACT_OVT_COST | decimal(25,6) | |
| ASSN_REM_OVT_COST | decimal(25,6) | |
| ASSN_RTF_NOTES | Image | RFU |
| ASSN_BOOKING_TYPE | Smallint | Indicates the booking type |
| | | of an assignment: |
| | | 0 = Committed (hard) |
| | | 2 = Proposed (soft) |
| ASSN_BINARY_DATA | Image | Same as ASSN table |
| ASSN_CONTOUR_DATA | Image | Same as ASSN table |
| ASSN_OVT_COST | decimal(25,6) | RFU |
| ASSN_STOP_DATE | Datetime | (not used) |
| ASSN_RESUME_DATE | Datetime | (not used) |
| ASSN_CHECKOUTBY | UID | |
| ASSN_CHECKOUTDATE | Datetime | |
| CREATED_DATE | Datetime | Date/time this row was |
| | | created. |
| MOD_DATE | Datetime | Date/time this row was last |
| | | updated. |
| MOD_REV_RANK | Int | |
| CREATED_REV_COUNTER | Int | The revision counter at |
| | | which the summary |
| | | resource assignment was |
| | | created |
| MOD_REV_COUNTER | Int | The revision counter at |
| | | which the summary |
| | | resources assignment was |
| | | last modified |

Server level SRAs can be implemented in the published database 120 using the table above. The PROJ_UID field can be the GUID for the project for which the summary resource assignment was created. For a server level SRA, a special GUID can be stored in this column. The ASSN_NAME field stores the name of the summary resource assignment. Regular assignments get their names from an associated task. SRAs typically do not have an associated task, so they get their own names. This information is exposed in the published database 120.

In an embodiment, the application server 108 uses a number of application programming interfaces (API) to generate and manage server level SRAs. One API, designated “UpdateSummaryResourceAssignments (ProjectGuid, ResourceGuids. ProjDeleted),” is configured to generate the project level SRAs for a specified project (specified via the Project Guid) for the specified resources (specified via the resource Guid's) and updates the appropriate server level SRAs, including resource plan data. The server level SRAs are updated by first subtracting the old project level SRAs for the specified project and then adding the new project level SRAs for the specified project. The ProjDeleted is a Boolean flag. If set, the project level SRA data is subtracted from the server level SRA data and then the project level SRA(s) are deleted for the resource(s) specified by the Resource Guid's in the project as specified via the Project Guid.

In one embodiment, once a project is published, the application server 108 is configured to loop through each resource of each project and generate a current project level SRA which consists of resource and assignment data. The application server 108 then subtracts prior project level SRA data from prior server level SRA data. Thereafter, the application server 108 adds the current project level SRA data to the difference to obtain the current server level SRA for each resource. The application server 108 is configured to obtain a current server level SRA for each resource associated with a project and/or resource plan.

A second API is designated “UpdateSummaryResourceAssignments (ProjectGuid, ResourceGuids. SRATimephaseData),” and is configured to generate SRA data for administrative time, such as for Timesheets for example. SRATimephaseData is an array containing the time phased information such as start and finish date values, etc. A third API, designated “RecreateServerLevelSummaryResourceAssignments(ResourceGuids),” is configured to regenerate the server level SRAs for the specified resources (specified via the resource Guid's). The server level SRAs are regenerated using the project level SRAs that are currently stored in the published database 120. If a server level SRA does not yet exist, the third API can be called to determine a current server level SRA. As described above, server level SRAs provide resource utilization information through project data, calendar data, non-administrative time data, resource plan data, etc.

The project management application 104, 110 includes an object model having certain properties and functionality. In one embodiment, the object model includes an Assignment property called “Summary” that is available through the user interface, by way of the Resource Usage view for example. This property can be set to “True” for SRAs and “False” for assignments and other allocations in currently open projects. The property can be used to filter out summary resource assignments to reduce data clutter in the Resource Usage view. The Summary property can be made available and used as a filter in the Resource Usage view. Code can be developed and implemented, using Visual Basic (VB) for example, to traverse the object model and distinguish between current assignments and summary assignments, as shown in the example code below.

```
Sub foo( )
  Dim oRes As Resource
  Dim oAssn As Assignment
  For Each oRes in Application.ActiveProject.Resources
    Debug.Print “Assignments for resource “ & oRes.Name
    For Each oAssn In oRes.Assignments
      If oAssn.Summary = True Then
          Debug.Print “ Summary assignment for “; oAssn.TaskName
      Else
          Debug.Print “ Task assignment for “; oAssn.TaskName
      End If
    Next oAssn
  Next oRes
End Sub
```

In various embodiments, the application server 108 provides time-phased assignment data for the project level and server level SRAs. For example, the time-phased assignment data can include, but is not limited to: Work, Regular Work, Actual Work, Actual Work Protected, and/or Actual Overtime Work. The project management application calculates total task work (“Work”) as the sum of the work that all assigned resources are to perform on a task. This can be based on the assignment span, the number of resources assigned, and the assignment units for the assigned resources. In one embodiment, work includes actual work and remaining work, as well as overtime work.

Regular Work=Work−Overtime Work

When a user first assigns a task to a resource, the Actual Overtime Work assignment field contains zero. As the assigned resource for the task reports any actual overtime work, it is entered into the Actual Overtime Work field.

The Actual Work field contains “0 hrs” if a user has not begun tracking an associated project. As actual work information is entered for tasks, or percent of work complete, the project management application updates the assignment's actual work values.

The Actual Work Protected field for the assignment contains “0 hrs” until the assigned resource starts to submit hours worked for this assignment. The resource enters actual work amounts in the timesheet. The resource sends the project manager updates for each reporting period. In an embodiment, as soon as a resource's actual work amounts are accepted by the project manager, those amounts are locked into the assignment's Actual Work Protected field and cannot be edited.

The following assignment fields can be calculated dynamically at display time based on the SRA work data and the latest resource availability data which includes, but is not limited to: Overallocation (time), Peak Units, and/or percent (%) allocation. For example, a database table including data fields for the associated data can be to manage time-phased assignment data and other data.

### Exemplary Operating Environment

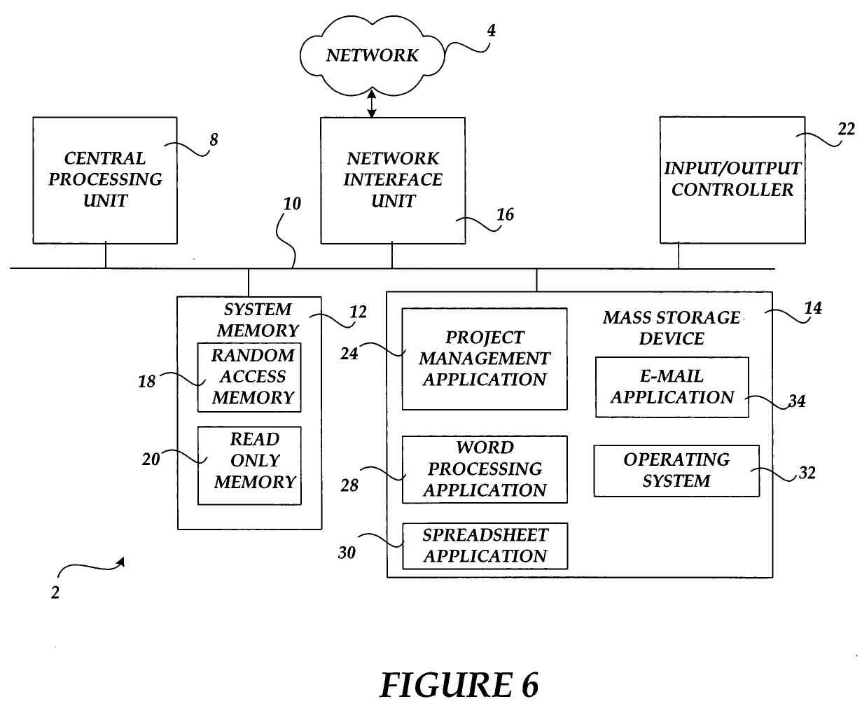

Referring now to FIG. 6, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 6, an illustrative operating environment for embodiments of the invention will be described. As shown in FIG. 6, computer 2 comprises a general purpose desktop, laptop, handheld, or other type of computer capable of executing one or more application programs. In particular, according to the various embodiments of the invention, the computer 2 is operative to execute a project management application 24, as described in detail above. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 32, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 32 suitable for controlling the operation of a networked personal computer, such as the WINDOWS XP operating system from MICROSOFT CORPORATION of Redmond, Wash. The mass storage device 14 and RAM 18 may also store one or more program modules. In particular, the mass storage device 14 and the RAM 18 may store application programs, such as a word processing application 28, a spreadsheet application 30, e-mail application 34, drawing application, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

We claim:

1. A computer readable medium including executable instructions which, when executed, manage project data by:
selecting a resource for an amount of time, wherein the resource is associated with one or more projects;
allocating the amount of time to the resource;
tracking utilization information including the allocated amount of time associated with the resource; and,
associating a server level summary with the resource, wherein the server level summary provides an overview of the tracked utilization information for an associated server.

2. The computer-readable medium of claim 1, wherein the instructions, when executed, manage project data by calculating an amount of actual work for the resource, wherein the server level summary includes the calculated amount of actual work.

3. The computer-readable medium of claim 1, wherein the instructions, when executed, manage project data by using the server level summary to determine whether other projects affect the availability of shared resources during at least one of a resource leveling operation and a resource substitution operation.

4. The computer-readable medium of claim 1, wherein the instructions, when executed, manage project data by using a publish operation to determine at least one of when to generate and update a server level summary resource assignment (SRA).

5. The computer-readable medium of claim 4, wherein the instructions, when executed, manage project data by presenting the server level SRA and other data to a user after the publish operation.

6. The computer-readable medium of claim 5, wherein the instructions, when executed, manage project data by controlling the amount of other data presented to the user based in part on one or more permissions associated with the user.

7. The computer-readable medium of claim 4, wherein the instructions, when executed, manage project data by managing the server level SRA by queuing a project and executing the project publish call in an order.

8. The computer-readable medium of claim 1, wherein the instructions, when executed, manage project data by using the server level summary in conjunction with a resource plan in determining an availability of the resource.

9. The computer-readable medium of claim 1, wherein the instructions, when executed, manage project data by transferring a server level SRA and the tracked utilization information from a first database to a second database in conjunction with the publish operation.

10. The computer-readable medium of claim 1, wherein the instructions, when executed, manage project data by updating a server level SRA when the resource is associated with at least one of a different project and a different resource plan.

11. The computer-readable medium of claim 10, wherein the instructions, when executed, manage project data by updating server level SRA data by subtracting old project level SRA data from current server level SRA data and adding current project level SRA data to the difference.

12. The computer-readable medium of claim 1, wherein the instructions, when executed, manage project data by using a summary property of an object model to present the server level summary.

13. A system to manage project data, the system comprising:
a project management application configured to manage one or more server level summaries, wherein each server level summary is associated with a resource;
a database to store resource data associated each server level summary; and,
a user interface to interact with the project management application, wherein the user interface is configured to present the resource data associated with each server level summary.

14. The system of claim 13, further comprising a draft database and a published database, wherein the resource data is transferred from the draft database to the published database in conjunction with a publish operation.

15. The system of claim 13, wherein the project management application further comprises an object model having a summary property, wherein the summary property can be used to control a display of each server level summary.

16. A method of managing project data, the method comprising:
presenting a server level summary that is associated with a resource, wherein the server level summary is associated with a publish operation and comprises a summary view of the resource utilization for an associated server;
allocating the resource to a project, wherein the allocation is based in part on the information provided by the server level summary; and,
updating the server level summary based in part on the allocation of the resource to the project.

17. The method of claim 16, further comprising calculating an amount of actual work for the resource.

18. The method of claim 16, further comprising presenting a server level SRA without presenting one or more project level SRAs.

19. The method of claim 16, further comprising updating server level SRA data by subtracting old project level SRA data from current server level SRA data and adding current project level SRA data to the current server level SRA data.

20. The method of claim 16, further comprising generating a permission for the server level summary, wherein a restricted amount of information is presented to a user who does not have the permission.
